(19) United States
(12) Patent Application Publication
(10) Pub. No.: US 2006/0020553 A1
(43) Pub. Date: Jan. 26, 2006

(54) License proxy process to facilitate license sharing between a plurality of applications

(76) Inventor: Daven Walt Septon, Loveland, CO (US)

Correspondence Address: AGILENT TECHNLOGIES, INC.;Legal Department, DL429, Intellectual Property Administration, P.O. Box 7599, Loveland, CO, 80537-0599, US

(21) Appl. No.: 10/899,760

(22) Filed: Jul. 26, 2004

(51) Int. Cl. G06F 11/30

(52) U.S. Cl. 705/59

(57) ABSTRACT

In one embodiment, a license proxy process transmits to a license server a request for a license that is to be shared by a plurality of applications. After the license proxy process receives the license from the license server, it stores license information corresponding to the license in a memory that is shared by the plurality of applications and the license proxy process.

### BACKGROUND

License servers are used to manage licenses that enable or enhance capabilities of applications. The licenses issued by a license server may comprise “node lock” licenses that are issued to a single machine, or “floating” licenses, which are not machine specific. As shown in FIG. 1, there are times when each of a plurality of applications 102, 104, 106 residing on a machine 100 require access to a license server 110. By way of example, the applications 102, 104, 106 may be standalone applications, or components (e.g., processes) of a larger application. At times, various of the applications 102, 104, 106 may be required to obtain the same license(s) from the license server 110, thereby resulting in multiple requests for a license being dispatched to the license server 110.

To maintain compliance with licensing agreements, the license server 110 may track the number of licenses it issues. However, if the license server 110 fails, it may lose its knowledge of issued licenses and, upon restart, its entire quantity of licenses may once again be made available. If one or more applications obtained licenses before the license server failure, and the license server reissues these licenses to additional applications after it is restarted, license over-usage becomes possible.

In order to prevent license over-usage, the applications 102, 104, 106 may send heartbeats to the license server 110 at predetermined time intervals. If the license server 110 fails, the applications 102, 104, 106 will not receive acknowledgements of their heartbeats, and appropriate action(s) can be taken.

For circuit test applications that rely on licenses provided by a FLEXIm™ license server (a license server offered by Macrovision Corporation, a Delaware Corporation having its principal place of business in Santa Clara, Calif., USA), the heartbeats provided by the circuit test applications may be executed within a few milliseconds. However, if a circuit test application is executing tests within nanoseconds, or even picoseconds, a few milliseconds is a long time, and the application's need to execute heartbeats can degrade the application's performance. If several processes within a circuit test application all need to obtain licenses and provide heartbeats, the overhead for maintaining the application's licenses can become quite significant. Similar performance degradation is also suffered by other multi-process applications. In the past, programmers have merely suffered the performance “hit” of heartbeat execution; or, programmers have circumvented or disabled an application's need to provide heartbeats. In the latter case, a user of the application may fail to comply with their license requirements.

### SUMMARY OF THE INVENTION

In one embodiment, a license proxy process transmits to a license server a request for a license that is to be shared by a plurality of applications. After the license proxy process receives the license from the license server, it stores license information corresponding to the license in a memory that is shared by the plurality of applications and the license proxy process.

Other embodiments are also disclosed.

### BRIEF DESCRIPTION OF THE DRAWINGS

Illustrative and presently preferred embodiments of the invention are illustrated in the drawings, in which:

FIG. 1 illustrates a prior art system that may be used by an application to obtain licenses;

FIG. 2 illustrates an exemplary embodiment of a system that uses a license proxy process to obtain licenses for a plurality of applications, with some of the licenses being shared by two or more of the applications;

FIG. 3 illustrates a circuit tester that employs the license proxy process and shared memory of FIG. 2;

FIG. 4 illustrates how a plurality of applications may share a license;

FIG. 5 illustrates an exemplary method that may be implemented by the license proxy process of FIGS. 2 or 3 to acquire a license; and

FIG. 6 illustrates an exemplary method that may be implemented by the license proxy process of FIGS. 2 or 3 to transmit heartbeats to a license server.

### DETAILED DESCRIPTION OF THE INVENTION

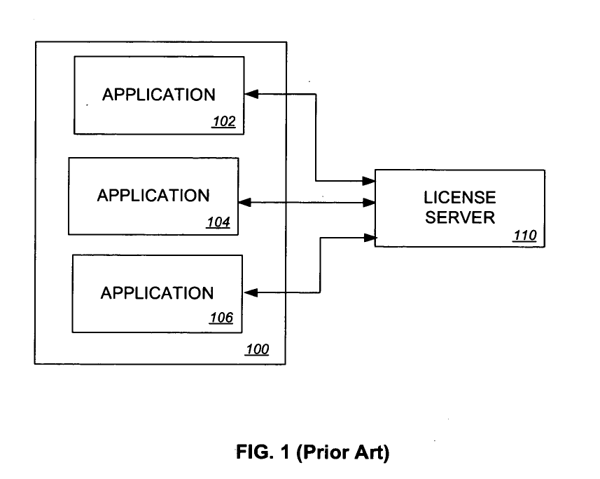

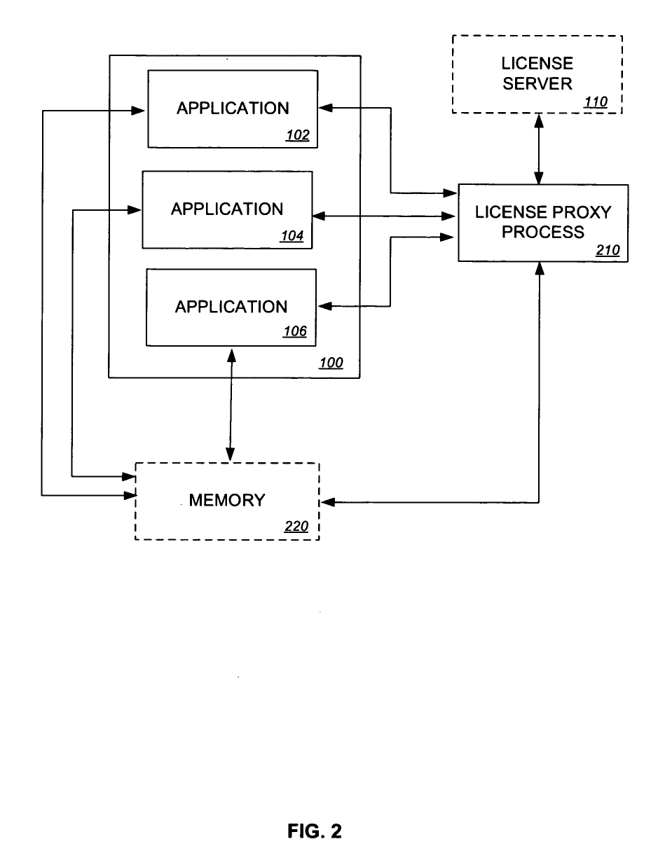

An exemplary embodiment of a system that uses a license proxy process to obtain licenses and store license information is illustrated in FIG. 2. The system comprises a plurality of applications 102, 104, 106, which may be standalone applications, or components (e.g., processes) of a larger application. The applications 102, 104, 106 reside on a machine 100, such as a computer server or workstation. Each of the applications 102, 104, 106 may require one or more licenses to enable the application in its entirety, or to enable a function or capability of the application. It should be appreciated that alternate embodiments of such a system may have numbers or types of applications 102, 104, 106 that differ from those shown in FIG. 1.

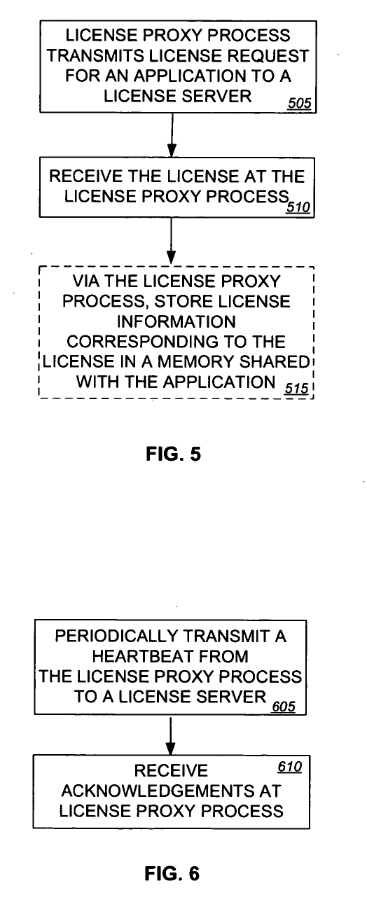

Each of the applications 102, 104, 106 may be communicatively coupled to a license proxy process 210. As defined herein, a communicative coupling is any sort of coupling that allows for communication between two processes. By way of example, a communicative coupling may comprise a socket or other software coupling, and/or a bus, cable, network, wireless mechanism, or other mechanism. Thus, it should be appreciated that license proxy process 210 and applications 102, 104, 106 may reside on the same or different machines. It should also be appreciated that, in some embodiments, the applications 102, 104, 106 may be components (e.g., processes) of a larger application. As will be described in further detail below, with reference to FIGS. 5 and 6, the license proxy process 210 may be responsible for obtaining licenses for the applications 102, 104, 106 and periodically transmitting heartbeats to a license server 110. Some of the licenses obtained by the license proxy process 210 may be shared by two or more of the applications 102, 104, 106.

The license proxy process 210 is communicatively coupled to the license server 110. By way of example, the license server 110 may be a FLEXIm™ license server. However, the license server 110 may also take other forms. The license server 110 may be used to issue and control licenses for one or more applications, including applications 102, 104, 106. Licenses issued by the license server 110 may be used to enable applications, or to enhance or govern the capabilities of applications (including the capabilities of hardware and firmware that may be controlled by the applications). In one embodiment, the license proxy process 210 is launched or initialized upon launch of one of the applications 102, 104, 106.

The system may optionally comprise a shared memory 220 that is communicatively coupled to and shared by the applications 102, 104, 106 and the license proxy process 210. The memory 220 may be used to store license information corresponding to one or more licenses that are obtained from the license server 110. License information may comprise the license type, the application and/or feature for which the license was issued, and/or other application specific information or types of information needed by applications 102, 104, 106. It should be appreciated that, in some embodiments, the license information may comprise the license obtained from license server 110. Alternately, the license information may simply be an indication that a license has been obtained (e.g., a Boolean flag). In some embodiments of the FIG. 2 system, the memory 220 may only be communicatively coupled to the license proxy process 210. In these embodiments, the applications 102,104, 106 are not able to communicate with the memory 220 directly and must instead communicate with the license proxy process 210 to obtain required license information.

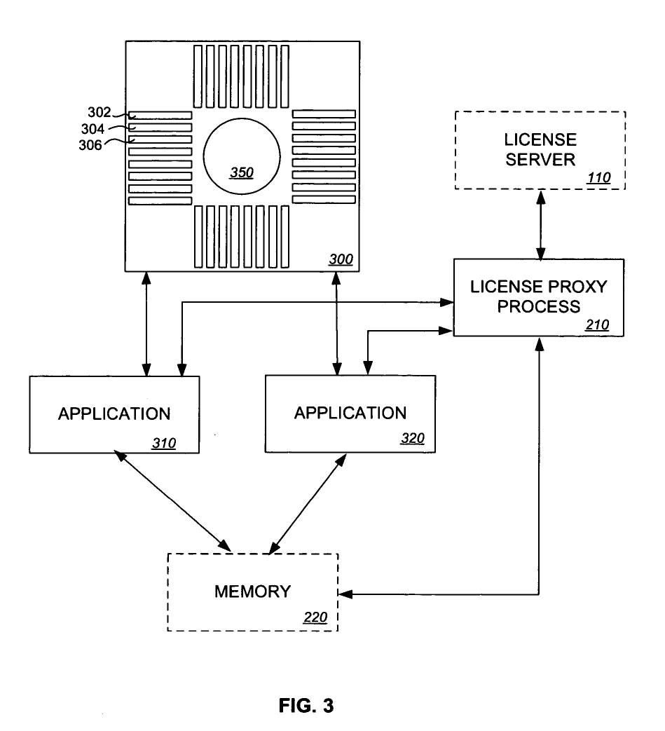

An exemplary circuit tester 300 that employs the license proxy process 210 is illustrated in FIG. 3. As shown, the circuit tester 300 may be configured to test a device 350, such as a system-on-a-chip (SOC) or other type of circuit. It should be appreciated that, at times, tester 300 may need to execute licensed applications while not coupled to a device 350.

As shown, tester 300 may comprise a plurality of boards 302-306. Each board may comprise a plurality of pins for driving inputs to, and receiving outputs from, device 350. In one embodiment, each pin may be associated with its own memory for storing test stimuli or test results (e.g., pin-specific vector information). In alternate embodiments of the tester 300, a dedicated memory may not be provided for each pin, but may instead be included for each board or other component of tester 300.

The circuit tester 300 may also comprise a plurality of applications, such as process 310 and process 320, that are communicatively coupled to tester 300. The processes 310, 320 may be part of a test operating system or application that is installed on a workstation coupled to tester 300 via a communication link such as an optical link. The processes 310, 320 may be used to control and enable features of the tester 300. In one embodiment, process 310 may communicate with firmware on tester 300 to set-up tests (possibly including multi-port tests) for device 350, and process 320 may receive test results from device 350. In an alternate embodiment, the processes 310, 320 may be part of the firmware of tester 300.

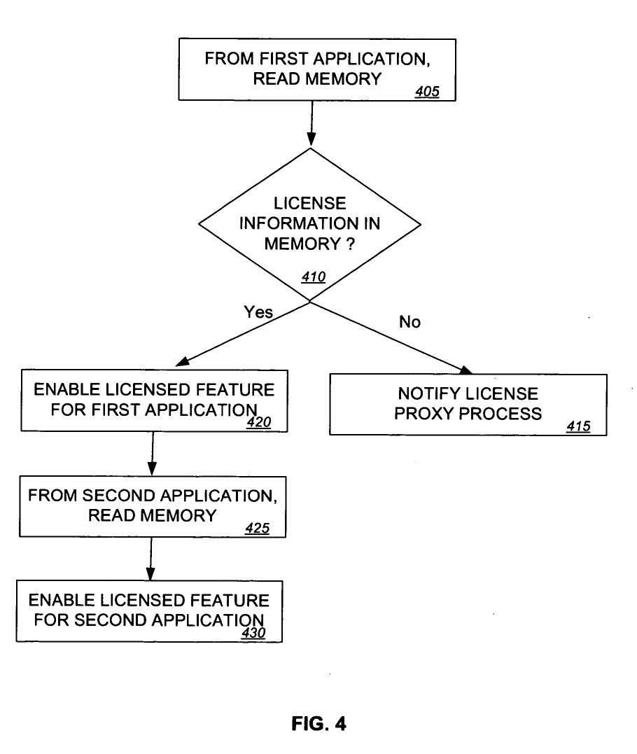

Processes 310, 320 may require one or more licenses to execute or enable capabilities of the processes. As will be described in further detail below with reference to FIG. 4, the license proxy process 210 may be used to obtain licenses for each of the processes 310, 320; or, the license proxy process 210 may be used to obtain a license that can be shared between the processes 310, 320. The licenses obtained by the license proxy process 210 may optionally be stored in the memory 220 that is shared with the processes 310, 320. It should be appreciated that in alternate embodiments, licenses may also be shared with additional processes. As will be described with reference to FIG. 6, after a license has been obtained, the license proxy process 210 may then be used to issue heartbeat communications to the license server 110.

By way of example, a license obtained by the license proxy process 210 may be used to enable all of the capabilities of the tester 300 or may be used to grant limited use of resources (e.g., limited rights to use boards, pins, memory or functionality (e.g., speed, GUIs, algorithms, test development tools, or debug techniques)) of the tester 300.

FIG. 4 illustrates an exemplary method that may be used by applications 102, 104, 106 to share a license. When application 102 determines it requires a license, it reads 405 a memory 220 shared with the license proxy process 210. If the memory 220 contains license information for the license type required by the application 102, the application 102 can proceed with enablement 420 of licensed features for which the license was required. Application 104 and other additional applications 106 can also read 425 memory 220 and use 430 the same license. Thus, it should be appreciated that by using memory 220, a license may be shared between a plurality of applications 102,104,106, and overhead involved in the licensing process may be greatly reduced. It should also be appreciated, that in alternate embodiments, applications 102, 104,106 could obtain shared license information directly from license proxy process 210 without using the shared memory 220.

If 410 the memory 220 does not contain the required license information, the license proxy process 210 can be notified so that it can obtain the required license. In alternate embodiments, the application 102 may obtain the license directly from license server 110 and store it in the shared memory 220 for subsequent management by the license proxy process 210. The application 102 may then notify the license proxy process 210 to begin heartbeat communications for the license with the license server.

FIG. 5 illustrates an exemplary method that may be used to obtain a license for applications 102, 104,106 using the license proxy process 210. A license request is transmitted 505 from the license proxy process 210 to the license server 110. In response to the request, the license proxy process 210 receives 510 a license from the license server 110. It should be appreciated that before issuing the license, the license server 110 may check to make sure that a license is available. In an alternate embodiment, a license may not be available and, instead of receiving 510 a license, the license proxy process 210 may instead receive notification from the license server 110 that no license is available.

After the license is received 510, the license proxy process 210 may optionally store 515 license information corresponding to the license in shared memory 220. As previously described, the license information may include the license itself, a Boolean flag, and/or other types of information needed by the applications 102, 104, 106. In one embodiment, after a license has been received 510, an indication may be sent from the license proxy process 210 to the applications 102,104, 106 to notify them that a license has been obtained. Alternately, the applications 102, 104, 106 may read the memory 220 whenever they require a license. If license information is not present, the applications 102, 104, 106 may cause the license proxy process 210 to obtain a license, and then periodically poll the memory 220 to determine if license information has been obtained; or, an application may wait until it receives an indication from the license proxy process 210 that a license has been obtained. In some embodiments, the license proxy process 210 may proactively obtain one or more licenses for the applications 102, 104, 106, before they are required by the applications 102, 104, 106.

FIG. 6 illustrates an exemplary method that may be used by the license proxy process 210 to transmit 605 heartbeats to the license server 110. The heartbeat may be transmitted at predetermined time intervals so as to discover failures of the license server 110. If the license server 110 is running, the license server 110 may send an acknowledgement for each of the periodic heartbeats of the license proxy process 210. If the license server 110 fails, the license proxy process 210 will not receive 610 an acknowledgement to its heartbeat.

In some embodiments, if an acknowledgement to a heartbeat is not received, the licenses under which the applications 102, 104, 106 or 310, 320 are running may no longer be valid (e.g., because the license server 110 may have released all of its licenses during a failure). If the license proxy process 210 determines that a license indication is no longer valid, either because it failed to receive an acknowledgement to its heartbeat, or for some other reason, the license proxy process 210 can then take appropriate action. By way of example, “appropriate action” may take the form of notifying the application(s) 102, 104, 106, and/or attempting to reacquire a license from the license server 110. In some embodiments, the affected applications 102, 104, 106 may be allowed to continue running, while in other embodiments, the affected applications 102, 104, 106 may be halted until a valid license or licenses can be reacquired.

The heartbeat transmitted by the license proxy process 210 may be used to help prevent license over-usage. The heartbeat transmittal 605 may also serve as a notification to the license server 110 that a license is being used by the applications 102, 104, 106, and may serve to trigger an automatic reissue of the license to the license proxy process 210 after a restart of license server 110 following a failure. It should be appreciated that by using a license proxy process 210 to communicate heartbeats to the license server 110, license over-usage may be prevented with minimal or no impact on the performance of applications 102, 104, 106.

After the applications 102, 104, 106 have finished using a license, the applications 102, 104, 106, or a larger application of which they are a part, may send a notification to the license proxy process 210 that the license is no longer needed. The license proxy process 210 may then transmit a request to free the license to the license server 110. In one embodiment, this may be done by forwarding the notification received from one of the applications 102, 104, 106. The license server 110 may then make the license available to other applications. Additionally, after the applications 102, 104, 106 have finished using the license, either the license proxy process 210 or the applications 102, 104, 106 may remove the license information from the memory 220.

Given that a license may be shared by various applications 102, 104, 106, an application's release of a license does not necessarily mean that the license proxy process 210 can check the license back into the license server 110 and remove its information from memory 220. Rather, the license proxy process 210 can only release a license after it has been released by “all” of the applications 102, 104 106 that share it. A mechanism for tracking the number of applications that actively share a license may therefore be useful. One way to do this is by storing a license usage “count” for each license referenced in the memory 220. These counts can be initialized to zero, and then each time an application requests a license, the license's count may be incremented, and each time an application releases a license, the license's count may be decremented. The license proxy process 210 may then check a license back into the license server 110 only if the license's corresponding count is zero.

Although license usage counts could also be stored within the license proxy process 210, storing them within a shared memory 220 will usually make it easier for applications 102, 104, 106 to access them.

Sometimes, it may be desirable to allow sharing of some licenses, but require that other licenses be checked out on a “per application” basis. To facilitate the simultaneous use of both types of licenses, licenses provided by the license server 110 could be of the form [<license_type>, <quantity>, <shared_license_flag>], where shared_license_flag is a Boolean value that may be set to True or False. If True, the license_type may be shared by multiple applications, up to the specified quantity. If False, the license_type cannot be shared.

The methods described above may be performed by hardware components, or may be embodied in sequences of machine-executable instructions that may be used to cause a machine, such as a general-purpose or special-purpose processor, or logic circuits programmed with the instructions, to perform the actions of the methods. Alternatively, the methods may be performed by a combination of software, firmware, and/or hardware.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A system, comprising:
a plurality of applications; and
a license proxy process, communicatively coupled to the plurality of applications, to obtain a license to be shared between the plurality of applications.

2. The system of claim 1, further comprising a memory, communicatively coupled to the plurality of applications and the license proxy process, to store license information for the license.

3. The system of claim 2, further comprising a license server, communicatively coupled to the license proxy process to issue the license and transmit the license to the license proxy process.

4. The system of claim 2, wherein said license information comprises a license usage count that is incremented in response to applications requesting said license, and decremented in response to applications releasing the license.

5. The system of claim 1, wherein the license proxy process is further configured to, after receipt of said license by the license proxy process, periodically transmit a heartbeat to the license server.

6. The system of claim 5, wherein the license server is further configured to transmit an acknowledgement of at least one of the periodic heartbeats.

7. The system of claim 1, wherein one of the applications comprises a process to enable a feature of a circuit tester.

8. The system of claim 7, further comprising the circuit tester.

9. The method of claim 8, wherein the circuit tester comprises a system-on-a-chip (SOC) tester.

10. A method, comprising:
from a first application, reading a memory shared with a license proxy process and a second application;
if the memory contains license information for a required license, using the license information to enable a feature of the first application;
from a second application, reading the memory and using the license information to enable a feature of the second application; and
if the memory does not contain the license information, notifying a license proxy process.

11. The method of claim 10, further comprising:
upon use of the license by either of said applications, incrementing a license usage count associated with the license; and
upon release of the license by either of said applications, decrementing the license usage count associated with the license.

12. The method of claim 10, further comprising, if the memory does not contain the license information:
transmitting from the license proxy process to a license server, a request for the required license;
receiving, at the license proxy process, a license from the license server; and
storing license information corresponding to the license in the memory.

13. The method of claim 10, wherein using the license information to enable said feature of the first application comprises using the license to enable a first feature of a circuit tester.

14. The method of claim 10, further comprising, if the memory contains the license information, periodically transmitting a heartbeat from the license proxy process to the license server.

15. The method of claim 14, further comprising, receiving from a license server, at the license proxy process, an acknowledgement of at least one of said periodic heartbeats.

16. A method, comprising:
transmitting from a license proxy process to a license server, a request for a license that is to be shared by a plurality of applications; and
receiving, at the license proxy process, the license from the license server; and
storing license information corresponding to the license in a memory shared by the plurality of applications and the license proxy process.

17. The method of claim 16, further comprising, after receiving the license, periodically transmitting a heartbeat from the license proxy process to the license server.

18. The method of claim 17, further comprising, receiving from the license server, at the license proxy process, an acknowledgment of at least one of said periodic heartbeats.

19. The method of claim 16, further comprising, when each of the plurality of applications no longer requires the license, transmitting a request to free the license from the license proxy process to the license server, and removing said license information from the memory.

20. The method of claim 16, wherein transmitting a license request comprises transmitting a license request before the plurality of applications require the license.
